(19) United States
(12) Patent Application Publication
(10) Pub. No.: US 2004/0098602 A1
(43) Pub. Date: May 20, 2004

(54) Prerequisite rights

(75) Inventors: John DeTreville, Seattle, WA (US); Bob Atkinson, Woodinville, WA (US); Brian A. LaMacchia, Seattle, WA (US); M. Paramasivam, Seattle, WA (US)

Correspondence Address: BANNER & WITCOFF LTD.,, ATTORNEYS FOR MICROSOFT, 1001 G STREET , N.W., ELEVENTH STREET, WASHINGTON, DC, 20001-4597, US

(73) Assignee: Microsoft Corporation, Redmond, WA

(21) Appl. No.: 10/298,486

(22) Filed: Nov. 18, 2002

(51) Int. Cl. H04L 9/32

(52) U.S. Cl. 713/193

(57) ABSTRACT

A computer-implemented mechanism for granting rights to a resource is described. A license identifies one or more principals, resources, rights and conditions. The license also conditions a right to be granted on the existence of one or more prerequisite rights. Before allowing an entity to exercise the right to be granted, a resource or other entity checks to determine whether the prerequisite rights exist.

### FIELD OF THE INVENTION

The invention generally relates to the field of computer security and, more particularly, to the field of flexibly and efficiently providing secure access to digital works provided that one or more prerequisite rights are satisfied.

### BACKGROUND

Authorization policy languages and data structures are frequently used to grant users rights to access digital data or other resources. Conventional authorization policy languages and data structures can express licenses which grant rights. A license typically identifies its issuer, the user or principal being granted the right, the specific right granted, the resource to which the license grants access, and any conditions that must be satisfied before the license is to be considered valid. FIG. 1 illustrates a conventional mechanism for granting rights to access a resource 102. Resource 102 may be a digital work in the form of an image, an audio or video file, an e-book, or the like. When an appropriately trusted issuer 104 desires to grant users 106, 108 and 110 access to resource 102, the trusted issuer may issue three separate licenses 112, 114 and 116. Each license identifies the principal or user 106, 108 or 110, resource 102, the right granted and any conditions.

There are several drawbacks to the mechanism of granting rights in the manner shown in FIG. 1. Issuing a separate license to each user, and for each resource that can be accessed, can be an overwhelming burden on trusted issuer 104. For example, issuing licenses to one million separate users, each of which can access up to one thousand separate resources, can require up to one billion separate licenses to be issued. Moreover, an authorization policy language and data structure that requires a unique license for each activity of each user necessarily allows the trusted issuer to track the activities of the users, thus necessarily creating a privacy concern. For example, if user 110 requests a series of licenses to access a series of resources, trusted issuer 104 may use that information to include user 110 in a targeted advertising campaign or in other ways not desired by user 110.

Therefore, there is a need in the art to extend authorization languages and data structures to limit the number of licenses that must be issued by a trusted issuer and to protect the privacy of users of licenses.

### SUMMARY

One or more of the above-mentioned needs in the art are satisfied by the disclosed authorization languages and data structures. The disclosed languages and data structures extend existing languages by conditioning a right on the existence of one or more prerequisite rights. Each prerequisite right may be in a separate license issued by various trusted issuers. When analyzing a license that grants a right conditioned on the existence of one or more prerequisite rights, depending on the embodiment, a resource, a mediating access control module or any other entity first determines if the user has the prerequisite rights before allowing the user to exercise the right granted by the license.

### BRIEF DESCRIPTION OF THE DRAWINGS

Aspects of the present invention are described with respect to the accompanying figures, in which like reference numerals identify like elements, and in which:

FIG. 1 illustrates a prior art mechanism for granting rights to access a resource;

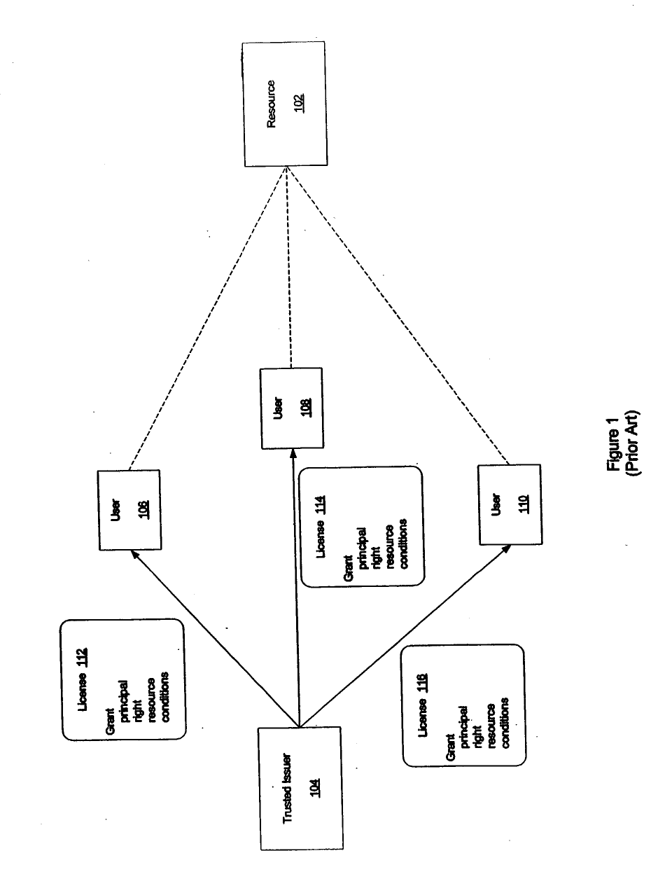

FIG. 2 shows an illustrative distributed computing system operating environment that may be used to implement aspects of the invention;

FIG. 3 illustrates a system for granting rights to a resource, in accordance with an embodiment of the invention;

FIG. 4 illustrates an exemplary implementation of the system shown in FIG. 3, in accordance with an embodiment of the invention;

FIG. 5 illustrates a license data structure, in accordance with an embodiment of the invention; and

FIG. 6 illustrates a method used by an access control module or parsing module in accordance with an embodiment of the invention.

### DETAILED DESCRIPTION

Aspects of the present invention permit the use of languages and data structures to engender a more efficient and more flexible granting of rights to access various resources, and to permit the extension of existing languages by conditioning a right on the existence of another right. Each right may in general be granted in a separate license issued by possibly different trusted issuers.

Exemplary Operating Environment

Aspects of the present invention are suitable for use in a distributed computing system environment. In a distributed computing environment, tasks may be performed by remote computer devices that are linked through communications networks. The distributed computing environment may include client and server devices that may communicate either locally or via one or more computer networks. Embodiments of the present invention may comprise special purpose and/or general purpose computer devices that each may include standard computer hardware such as a central processing unit (CPU) or other processing means for executing computer executable instructions, computer readable media for storing executable instructions, a display or other output means for displaying or outputting information, a keyboard or other input means for inputting information, and so forth. Examples of suitable computer devices include hand-held devices, multiprocessor systems, microprocessor-based or programmable consumer electronics, networked PCs, minicomputers, mainframe computers, and the like.

The invention will be described in the general context of computer-executable instructions, such as program modules, that are executed by a processing device, including, but not limited to a personal computer. Generally, program modules include routines, programs, objects, components, data structures, etc., that perform particular tasks or implement particular abstract data types. Typically the functionality of the program modules may be combined or distributed as desired in various environments.

Embodiments within the scope of the present invention also include computer readable media having executable instructions. Such computer readable media can be any available media that can be accessed by a general purpose or special purpose computer. By way of example, and not limitation, such computer readable media can comprise RAM, ROM, EEPROM, CD-ROM or other optical disk storage, magnetic disk storage or other magnetic storage devices, or any other medium which can be used to store the desired executable instructions and which can be accessed by a general purpose or special purpose computer. Combinations of the above should also be included within the scope of computer readable media. Executable instructions comprise, for example, instructions and data which cause a general purpose computer, special purpose computer, or special purpose processing device to perform a certain function or group of functions.

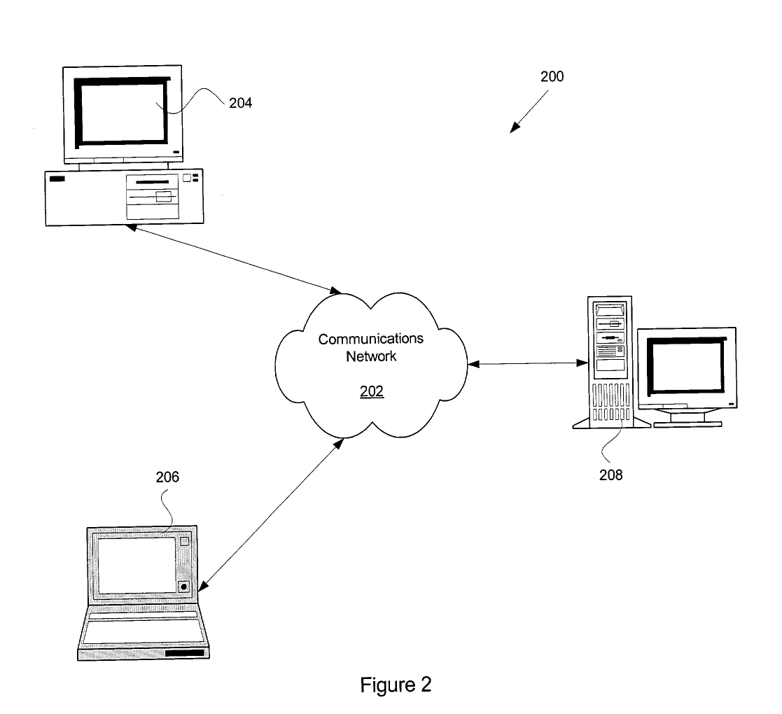

FIG. 2 illustrates an example of a suitable distributed computing system 200 operating environment in which the invention may be implemented. Distributed computing system 200 is only one example of a suitable operating environment and is not intended to suggest any limitation as to the scope of use or functionality of the invention. System 200 is shown as including a communications network 202. The specific network implementation used can be comprised of, for example, any type of local area network (LAN) and associated LAN topologies and protocols; simple point-to-point networks (such as direct modem-to-modem connection); and wide area network (WAN) implementations, including public Internets and commercial based network services such as the Microsoft Network or America Online's network. Systems may also include more than one communication network, such as a LAN coupled to a long-haul network.

Computer device 204, computer device 206 and computer device 208 may be coupled to communications network 202 through communication devices. Network interfaces or adapters may be used to connect computer devices 204, 206 and 208 to a LAN. When communications network 202 includes a WAN, modems or other means for establishing communications over WANs may be utilized. Computer devices 204, 206 and 208 may communicate with one another via communication network 202 in ways that are well known in the art. The existence of any of various well-known protocols, such as Ethernet, TCP/IP, FTP, HTTP and the like, is presumed. Computer devices 204, 206 and 208 may exchange content, applications, messages and other objects via communications network 202.

Description of Illustrative Embodiments

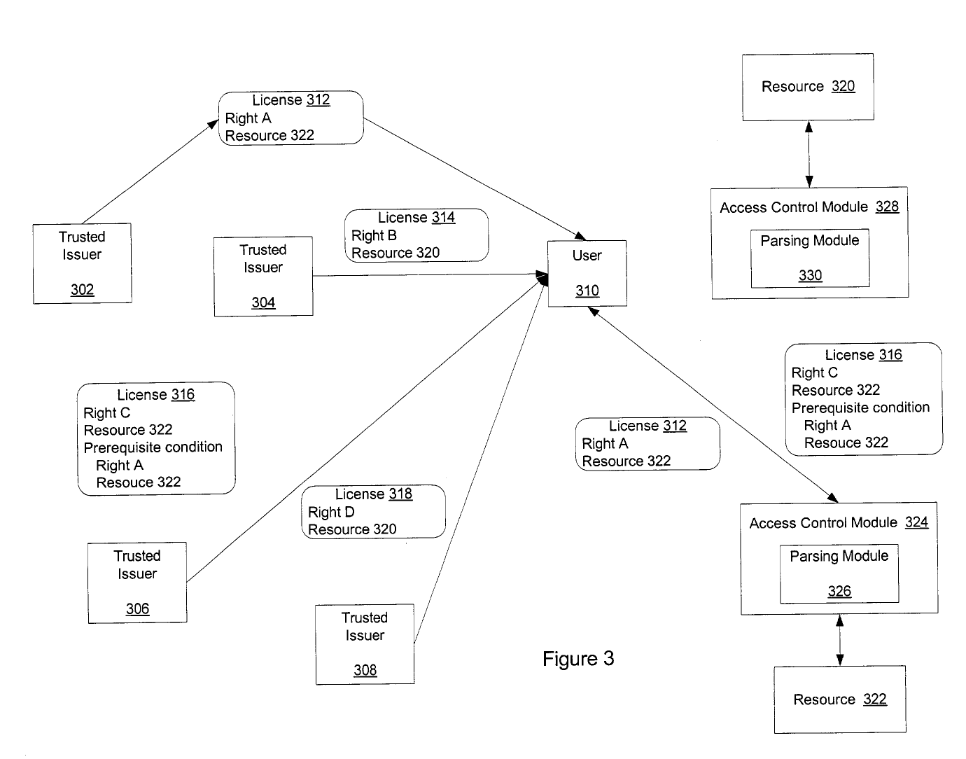

FIG. 3 illustrates a mechanism for granting rights to resources in accordance with an embodiment of the invention. The embodiment shown in FIG. 3 includes four appropriately trusted issuers 302, 304, 306 and 308. Each trusted issuer may issue licenses to user 310. A single user 310 is shown for illustration purposes only and with the understanding that aspects of the present invention may be used with configurations that include two or more users. Licenses 312, 314, 316 and 318 provide rights to resources 320 and 322. Similarly, several trusted issuers are shown for purposes of illustration, though it should be understood that any number of trusted issuers, including one, may be used. Licenses 312, 314 316 and 318 may be expressed in a usage rights language defined by a grammar, including but not limited to logic-programming languages and eXtensible Markup Language (XML) derivatives, such as eXtensible rights Markup Language (XrML), version 2.0. In other aspects of the invention, licenses 312, 314, 316 and 318 may be expressed as a data structure in a programming language. For example, object-oriented programming languages, including but not limited to C++, Java, Eiffel, C#, Objective C, and Common Lisp may be used to express an authorization policy. Further, other programming languages and their accompanying data structures may also be used to express an authorization policy, including but not limited to C and assembly language.

Resources 320 and 322 may be one of a broad variety of different forms. For example, each may be a digital work in the form of an image, an audio or video file, an e-book or some other digital file or service for which access thereto is readily controllable by an electronic grant (for example, downloadable information or content). Alternately, non-digital resources may be encompassed by the scope of the invention. For example, a non-digital resource (such as a cup of coffee at a local coffee house or permission to see a movie at the local theater) may be controlled by the grant of the right embodied in some physical way (a debit card good for a cup of coffee, a gate at the theater, and the like). Each license may include a right that is conditioned upon the existence of one or more prerequisite rights. For example, license 316 conditions right C to resource 322 upon the possession of prerequisite right A to resource 322. That is, user 310 may not exercise right C with respect to resource 322 unless user 310 also possesses right A. When user 310 desires to exercise right C with respect to resource 322, user 310 may transmit licenses 312 and 316 as credentials or other input evidence to an access control module 324.

Access control module 324 may be a software or hardware module which may be used to control access to resource 322. Access control module 324 may reside locally or remotely to corresponding resource 322, user 310, and/or trusted issuers 302, 304, 306, and 308. Access control module 324 may include a parsing module 326 to parse and interpret licenses. In one particular embodiment that uses licenses formatted in accordance with extensible rights markup language (XrML) schemas, parsing module 326 parses an XrML document to obtain license data. FIG. 3 shows an embodiment in which resource 320 is coupled to a separate access control module 328 and parsing module 330. In an alternative embodiment, resources 320 and 322 may be coupled to the same access control module and/or parsing module.

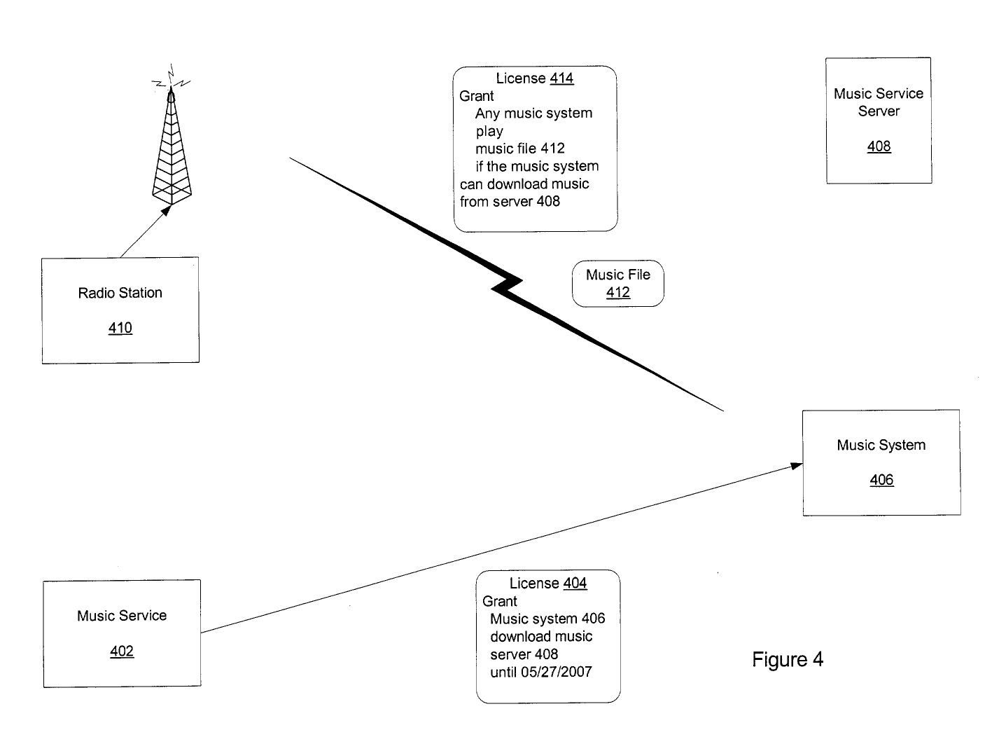

FIG. 4 shows an illustrative implementation of the general mechanism shown in FIG. 3. A music service 402 issues a license 404 to a music system 406. License 404 allows music system 406 to download music from a music service server 408. License 404 also includes a condition that the right must be exercised before May 27, 2007. Music service 402 may correspond to a music club and music system 406 may be a member of the club and may be implemented with a home stereo system, a music system installed in a vehicle or a portable music system.

A radio station 410 broadcasts music files, such as music file 412 to music system 406. Radio station 410 limits access to music file 412 to only those entities that are allowed to download music from music service server 408. For example, radio station 410 and music service 402 may enter into an agreement where radio station 410 is provided an incentive to provide music content to those entities that subscribe to music service 402. With prior art license mechanisms, if radio station 410 wanted to allow music system 406 to play music file 412, radio station 410 would be required to issue a specific license to music system 406.

Unlike prior art licenses mechanisms, aspects of the present invention may be used to control access to music file 412 by radio station 410 issuing a license 414 that conditions the right to play music file 412 on the prerequisite right that an entity can download music from music server 408. License 414 may be broadcast along with music file 412. An entity that receives music file 412 will not be able to play music file 412 without license 414 and proof that the prerequisite right is granted. In one embodiment of the invention, music file 412 may be encrypted and can only be decrypted using other information contained within license 414 when all the conditions included in license 414 are satisfied.

The mechanism shown in FIG. 4 helps protect the privacy of users. For example, radio station 410 does not have access to the membership list of music service 402. In fact, radio station 410 may not even know how many members belong to music service 402. Moreover, radio station 410 has no means of associating individual entities with the music files played by those entities. Another advantage is that the license processing decisions are distributed to the edge of the network. That is, several music systems or principals may participate in determining whether rights exist instead of requiring radio station 410 or a trusted issuer to determine whether each music system is allowed access to each music file or resource. It will be understood that although the prerequisite right in this implementation consists of the right of a user to perform a certain action, a prerequisite right more generally may include any fact that may be carried in a license, such as being over the age of 21 or being a member of a fan club. Moreover, a perquisite right may express at least one certified property of the principal, resource or a license issuer.

One skilled in the art will appreciate that the system shown in FIG. 4 is merely an illustration of one implementation of aspects of the present invention. In one alternative embodiment, a trusted issuer may issue a user a primary license to download a software product from a server. At a later date, the trusted issuer may develop an updated version of the software and wish to allow all users of the original version to download the updated software product. Instead of issuing individual licenses to the individual users, the trusted issuer may issue a secondary license that conditions the right to download the updated version of the software on the existence of the prerequisite right to download the original version of the software.

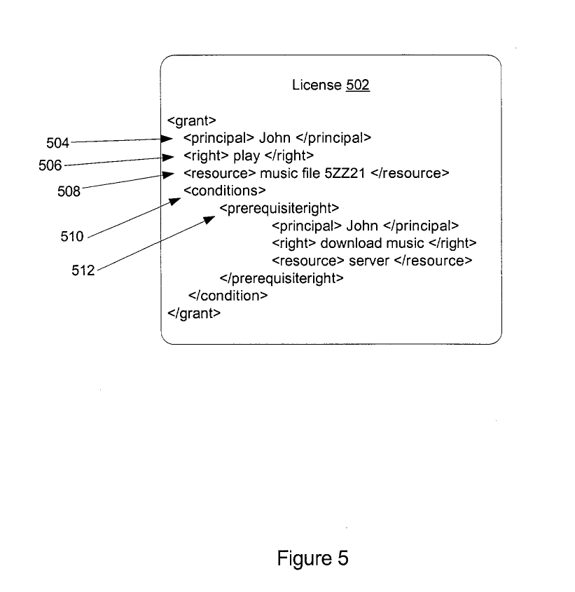

FIG. 5 illustrates a license data structure in accordance with an embodiment of the invention. License 502 may be formatted in accordance with a markup language. A first field 504 identifies the principal or user. A second field 506 identifies the right. Next, the resource is identified in field 508. One or more conditions may be identified in field 510. License 502 includes a condition in the form of a prerequisite right in field 512. As is shown, a prerequisite right may also include the identification of one or more principals, one or more rights and/or one or more resources. One skilled in the art will appreciate that several modifications may be made to license 502 without departing from the scope of the invention. For example a group or class of principals may be identified in field 504, and for any specific principal named in the group or class the license will only be “active” for that specific principal if that principal also possesses the prerequisite right. Similarly, a class of resources may be identified in field 508.

Moreover, it is not necessary that license 502 identify any particular resource. For example, a principal may have the right to perform some activity that does not involve a resource. In another example, a principal may have the right to perform one activity to some unspecified resource provided the principal has the right to perform some other activity on the same resource. For example, the right to print any (unspecified) document may be conditioned on the possession of the right to read the same (unspecified) document. License 502 may also include several different conditions, any number of which may be in the form of prerequisite rights. Moreover one or more of the prerequisite rights may themselves require one or more other prerequisite rights so that a chain, a tree, or a directed acyclic graph of prerequisite rights must exist before a right can be exercised. In one particular embodiment of the invention, licenses are formatted in accordance with an XrML schema.

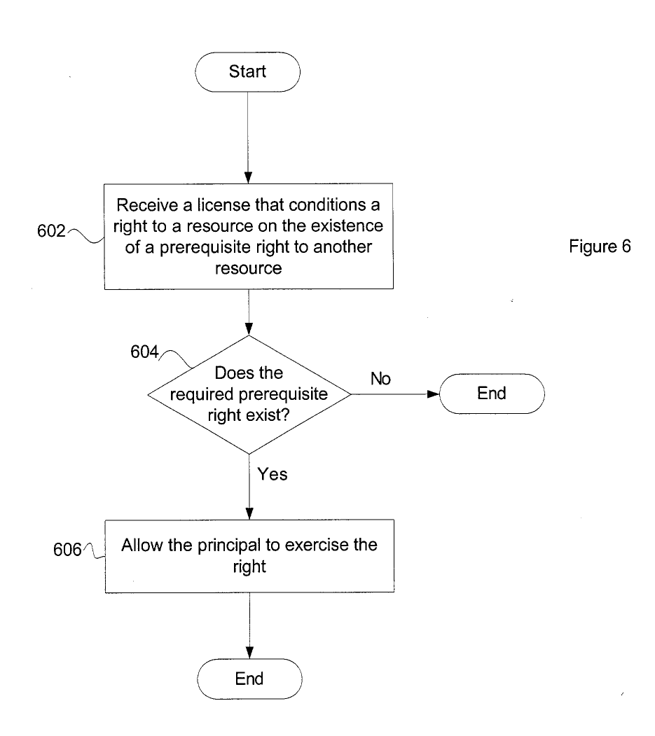

FIG. 6 illustrates a method that may be implemented by an access control module or a parsing module. First, in step 602, the module receives a license that conditions a right to a resource on the existence of one or more prerequisite rights to other resources. Alternatively, the right and the prerequisite rights may relate to the same resource. The license may also include one or more additional conditions that limit the right. For example, a condition may require the principal to pay a fee before exercising the right. Next, in step 604, the module may determine whether the prerequisite rights exist. Step 604 may include contacting the other resource or examining another license, causing the recursive invocation of this method. When a required prerequisite right does not exist, the process ends. When all necessary prerequisite rights do exist, in step 606, the principal is allowed to exercise the right.

Further embodiments of the invention may be implemented in hardware, software, or by an application specific integrated circuit (ASIC). The firmware may be in a read-only memory and the software may reside on a medium including, but not limited to, read-only memory, random access memory, floppy disk or compact disk.

The present invention has been described in terms of preferred and exemplary embodiments thereof. Numerous other embodiments, modifications and variations within the scope and spirit of the appended claims will occur to persons of ordinary skill in the art from a review of this disclosure.

We claim:

1. A computer-implemented method of processing a license issued to a principal and that grants rights to a resource, the method comprising:
(a) receiving a license that conditions a right to be granted to a primary principal to access a primary resource on the existence, with respect to one or more secondary principals, of one or more prerequisite rights to one or more secondary resources;
(b) determining whether the one or more prerequisite rights exist; and
(c) allowing the primary principal to exercise the right to be granted only when the one or more prerequisite rights exist.

2. The computer-implemented method of claim 1, wherein (c) further comprises:
allowing the primary principal to exercise the right only when all of the conditions identified in the license have been satisfied.

3. The computer-implemented method of claim 2, wherein at least one condition comprises paying a fee.

4. The computer-implemented method of claim 1, wherein the one or more prerequisite rights are included in one or more secondary licenses issued to the primary principal.

5. The computer-implemented method of claim 1, wherein the one or more prerequisite rights are included in secondary licenses issued to the one or more secondary principals.

6. The computer-implemented method of claim 1, wherein the same entity grants rights to the primary resource and the one or more secondary resources.

7. The computer-implemented method of claim 1, wherein a first entity grants rights to the primary resource and a second entity grants rights to the one or more secondary resources.

8. The computer-implemented method of claim 1, wherein the license is formatted in accordance with a usage rights language.

9. The computer-implemented method of claim 8, wherein the usage rights language is based on XML.

10. The computer-implemented method of claim 1, wherein the license is created as a data structure in a programming language.

11. The computer-implemented method of claim 1, wherein the right includes a right to download a digital file.

12. The computer-implemented method of claim 1, wherein the right includes a right to manipulate a digital file.

13. The computer-implemented method of claim 1, wherein the right includes a right associated with a service.

14. A computer-implemented method of granting a right to a resource, the method comprising: generating a license that grants a principal a primary right associated with a resource; wherein the primary right is contingent on the existence of one or more prerequisite rights.

15. The computer-implemented method of claim 14, wherein the one or more prerequisite rights are included in one or more secondary licenses issued to the principal.

16. The computer-implemented method of claim 14, wherein the one or more prerequisite rights express at least one certified property of the principal, resource or a license issuer.

17. The computer-implemented method of claim 14, wherein the license is formatted in accordance with a usage rights language.

18. The computer-implemented method of claim 17, wherein the usage rights language is based on XML.

19. The computer-implemented method of claim 14, wherein the license is created as a data structure in a programming language.

20. The computer-implemented method of claim 14, wherein the primary right includes a right to download a digital file.

21. The computer-implemented method of claim 14, wherein the primary right includes a right to manipulate a digital file.

22. The computer-implemented method of claim 14, wherein the right includes a right associated with a service.

23. A computer-readable medium containing computer-executable instructions for causing a computer device to process a license by performing the steps comprising:
(a) receiving a license that conditions a right to a primary resource on the existence of one or more prerequisite rights to secondary resources;
(b) determining whether the one or more prerequisite rights exist; and
(c) allowing a principal to exercise the primary right only when the one or more prerequisite rights exist.

24. A computer-readable medium having stored thereon a license data structure, said license data structure comprising:
a first field identifying a principal;
a second field identifying a right associate with a digital work; and
a third field identifying prerequisite rights that must exist before the principal can exercise the right associated with the digital work.

25. The computer-readable medium of claim 24, wherein the license data structure further includes:
a fourth field identifying at least one condition that must exist prior to the principal exercising the right.

26. The computer-readable medium of claim 25, wherein the at least one condition comprises the payment of a fee.
